(19) United States
(12) Patent Application Publication
(10) Pub. No.: US 2014/0337157 A1
(43) Pub. Date: Nov. 13, 2014

(54) SYSTEM AND METHOD FOR PROVIDING A MARKETPLACE FOR MOVING SERVICES

(71) Applicant: Joel Burlin, San Diego, CA (US)

(72) Inventor: Joel Burlin, San Diego, CA (US)

(21) Appl. No.: 13/888,527

(22) Filed: May 7, 2013

(51) Int. Cl. G06Q 30/06

(52) U.S. Cl. CPC G06Q 30/0611
USPC 705/26.4

(57) ABSTRACT

The present invention generally relates to computer and web-based marketplace for moving services. Specifically, this invention relates to systems and methods for providing consumers with quotes for moving services from multiple movers. Embodiments of the present invention allow a consumer to provide details about their move and for movers to provide a customized quote for services based upon the specifics of that consumer's move.

### FIELD OF THE INVENTION

The present invention generally relates to computer and web-based marketplace for moving services. Specifically, this invention relates to systems and methods for providing consumers with quotes for moving services from multiple movers. Embodiments of the present invention allow a consumer to provide details about their move and for movers to provide a customized quote for services based upon the specifics of that consumer's move.

### BACKGROUND

The experience of moving your home or business can be very challenging and stressful. One of the primary ways people try to alleviate that stress is by hiring a moving company to handle the move. The process of finding a reliable and fairly priced moving company, however, is in and of itself a stressful and time consuming task. Currently consumers that are interested in hiring a mover must usually spend time contacting and/or scheduling appointments with a number of different moving companies so that the moving companies can provide a quote for their services. This system, however, has a number of problems. First, for quotes that are verbally confirmed over the phone, there can be miscommunication and discrepancies that can cause the quote to be too high (causing the moving company to miss out on an opportunity) or too low (causing consumer dissatisfaction when then end up paying a higher cost). Additionally, the current system is inefficient as time must be spent actually speaking and/or meeting with a number of different people to obtain a quote. Finally, the current process of obtaining a quote for moving services makes it difficult to price shop and compare the services of different moving companies as the exact totals cost is not always known as a quote is inherently indefinite.

Therefore, there is need in the art for a computer and web-based marketplace system and method that provides an efficient way for a consumer to submit the details of their move one time and receive precise moving cost bids from multiple moving companies. These and other features and advantages of the present invention will be explained and will become obvious to one skilled in the art through the summary of the invention that follows.

### SUMMARY OF THE INVENTION

Accordingly, it is an aspect of the present invention to provide a system and method for a computer and web-based marketplace for moving services. In a preferred embodiment, the system and method provide a consumer with an efficient, one-stop solution to simultaneously receive bids for moving services from multiple moving companies.

According to an embodiment of the present invention, a system for providing a marketplace for moving services, the system comprising: a moving services bid generator, including a customer information module including computer-executable code stored in non-volatile memory, a mover information module including computer-executable code stored in non-volatile memory, a processor, and a communications means, wherein said customer information module, the mover information module, the processor, and the communications means are operably connected and are configured to: request estimate information from one or more movers, via the mover information module, wherein the estimate information is comprised of one or more estimate factors selected from a group of estimate factors including availability information, pricing unit, price per unit, loading cost adjustments, unloading cost adjustments, and special request cost adjustments, receive the estimate information from the one or more movers, wherein the one or more movers input the one or more estimate factors, request moving information from a customer, via the customer information module, wherein the moving information is comprised of one or more move specific details selected from a group of move specific details including an item inventory list, special requests, a move-out date, a move-in date, a move-out location, a move-in location, loading conditions, unloading conditions, and move type, receive the moving information from the customer, wherein the customer inputs the one or more move specific details, process the moving information and the estimate information, wherein the customer information module and the mover information module cooperate to compare the moving information to the estimate information, calculate one or more moving quotes, wherein the one or more moving quotes is based on a comparison of the moving information and the estimate information, wherein the one or more moving quotes are calculated according to a bid method selected from a group of bid methods including price-it bid method, secret bid method, and open bid method, and provide the one or more moving quotes to the customer, wherein each of the one or more moving quotes is associated with at least one of the one or more movers that provided the estimate information.

According to an embodiment of the present invention, the moving services bid generator, is further configured to receive a mover selection from the customer based on the customer selecting a preferred moving quote from the one or more moving quotes.

According to an embodiment of the present invention, the move type is selected from a group of move types including local moves and long distance moves.

According to an embodiment of the present invention, the pricing unit is selected from a group of pricing units including, price per unit of time, price per unit of volume, and price per unit of weight.

According to an embodiment of the present invention, the price-it bid method comprises receiving a favored price from the customer, comparing the favored price to the estimate information that is associated with at least one of the one or more movers, and approving the favored price if the favored price is within a designated range of the estimate information associated with at least one of the one or more movers.

According to an embodiment of the present invention, the secret bid method hides each of the one or more movers specific identities from the customer and instead provides one or more customer reviews and a mover rating for each of the one or more movers so that the customer can make the mover selection.

According to an embodiment of the present invention, the open bid method shows each of the one or more movers specific identities to the customer so that the customer can make the mover selection.

According to an embodiment of the present invention, a method for providing a marketplace for moving services, the method comprising the steps of: requesting estimate information from one or more movers, via the mover information module, wherein the estimate information is comprised of one or more estimate factors selected from a group of estimate factors including availability information, pricing unit, price per unit, loading cost adjustments, unloading cost adjustments, and special request cost adjustments, receiving the estimate information from the one or more movers, wherein the one or more movers input the one or more estimate factors, requesting moving information from a customer, via the customer information module, wherein the moving information is comprised of one or more move specific details selected from a group of move specific details including an item inventory list, special requests, a move-out date, a move-in date, a move-out location, a move-in location, loading conditions, unloading conditions, and move type, receiving the moving information from the customer, wherein the customer inputs the one or more move specific details, processing the moving information and the estimate information, wherein the customer information module and the mover information module cooperate to compare the moving information to the estimate information, calculating one or more moving quotes, wherein the one or more moving quotes is based on a comparison of the moving information and the estimate information, and providing the one or more moving quotes to the customer, wherein each of the one or more moving quotes is associated with at least one of the one or more movers that provided the estimate information.

According to an embodiment of the present invention, the method further comprising the step of receiving a mover selection from the customer based on the customer selecting a preferred moving quote from the one or more moving quotes.

According to an embodiment of the present invention, the move type is selected from a group of move types including local moves and long distance moves.

According to an embodiment of the present invention, the pricing unit is selected from a group of pricing units including, price per unit of time, price per unit of volume, and price per unit of weight.

According to an embodiment of the present invention, the price-it bid method comprises receiving a favored price from the customer, comparing the favored price to the estimate information that is associated with at least one of the one or more movers, and approving the favored price if the favored price is within a designated range of the estimate information associated with at least one of the one or more movers.

According to an embodiment of the present invention, the secret bid method hides each of the one or more movers specific identities from the customer and instead provides one or more customer reviews and a mover rating for each of the one or more movers so that the customer can make the mover selection.

According to an embodiment of the present invention, the open bid method shows each of the one or more movers specific identities to the customer so that the customer can make the mover selection.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a schematic of a moving services bid generator, in accordance with an embodiment of the present invention; and

FIG. 4 is a process flow of an exemplary method in accordance with embodiments of the present invention.

### DETAILED SPECIFICATION

The present invention generally relates to computer and web-based marketplace for moving services. Specifically, this invention relates to systems and methods for providing consumers with quotes for moving services from multiple movers. Embodiments of the present invention allow a consumer to provide details about their move and for movers to provide a customized quote for services based upon the specifics of that consumer's move.

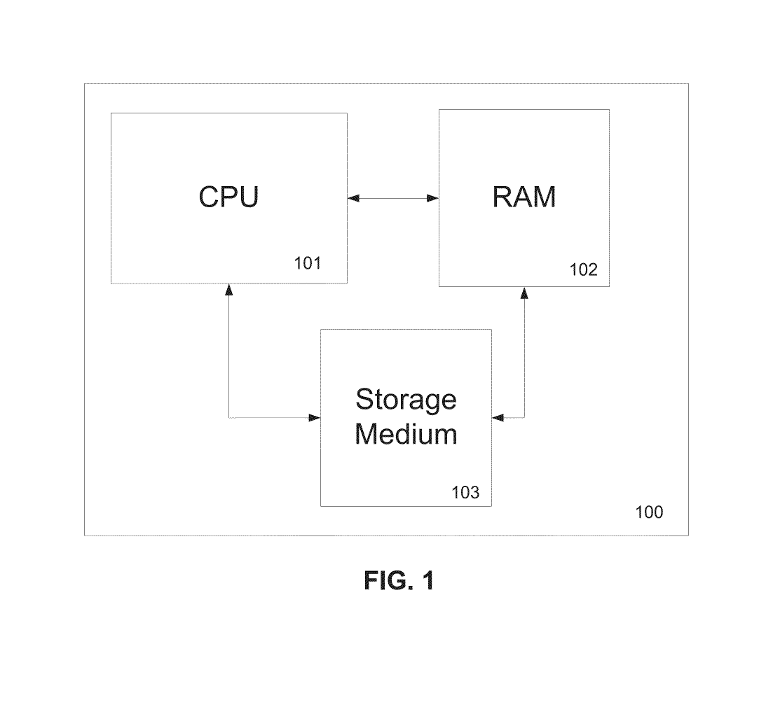

According to an embodiment of the present invention, the systems and methods are accomplished through the use of one or more computing devices. As shown in FIG. 1, one of ordinary skill in the art would appreciate that a computing device 100 appropriate for use with embodiments of the present application may generally be comprised of one or more of a Central processing Unit (CPU) 101, Random Access Memory (RAM) 102, and a storage medium (e.g., hard disk drive, solid state drive, flash memory, cloud storage) 103. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

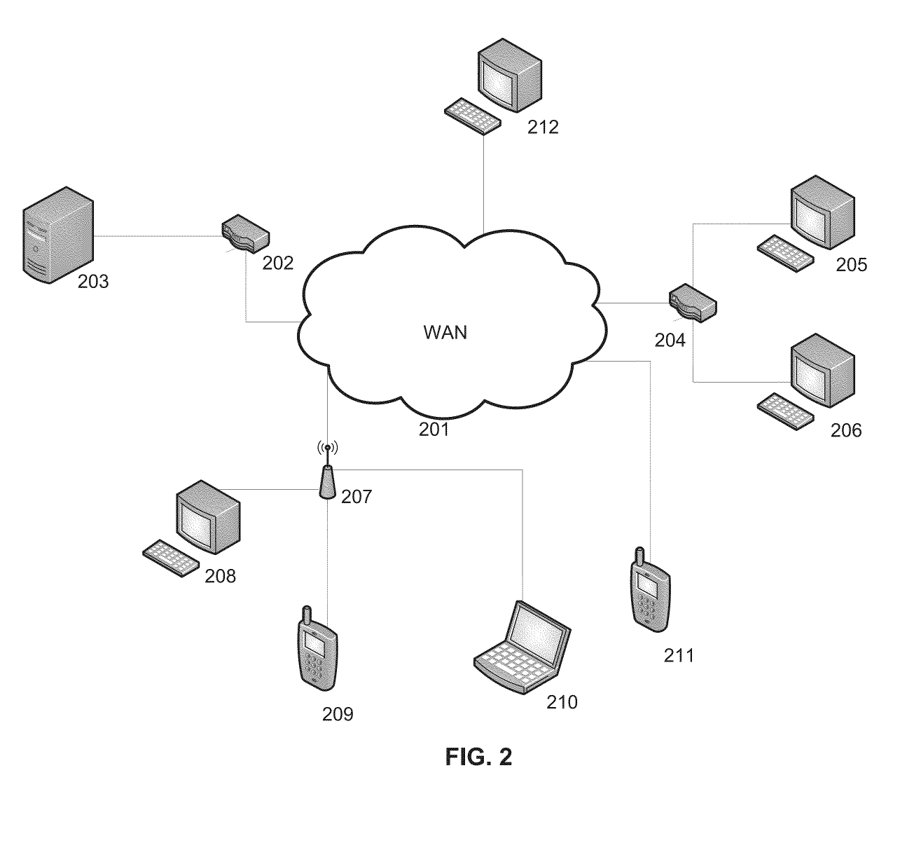

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to.

According to an embodiment of the present invention, a system for providing a marketplace for moving services includes a moving services bid generator. In a preferred embodiment, the moving service bid generator is comprised of a customer information module, a mover information module, a processor, and a communications means. In alternate embodiments, the moving services bid generator may have additional or fewer components. One of ordinary skill in the art would appreciate that a moving services bid generator may be operable with a number of optional components, and embodiments of the present invention are contemplated for use with any such optional component.

According to an embodiment of the present invention, the moving services bid generator is configured to provide one or more moving quotes to consumer. In a preferred embodiment, the consumer inputs moving information into the customer information module and a mover or moving company inputs estimate information into a mover information module. Then the customer information module and mover information module cooperate through the use of a processor to calculate a moving quote. In the preferred embodiment, the number of moving quotes a consumer receives will be primarily based on the number of movers or moving companies that submit estimate information. Conveniently, the consumer only needs to enter their moving information one time and a moving quote will be generated for each mover or moving company that submits estimate information.

According to an embodiment of the present invention, the communications means of the moving services bid generator may be, for instance, any means for communicating data over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the moving service bid generator includes a customer information module. In a preferred embodiment, the customer information module is configured to request, process and organize moving information from a customer. In the preferred embodiment, the customer information module may also coordinate with the mover information module in order to provide a moving quote to a consumer or similar user. One of ordinary skill in the art would appreciate that the customer information module could be configured to perform any number of tasks, and embodiments of the present invention are contemplated for performing any such task.

According to an embodiment of the present invention, the customer information module is configured to request, process and organize moving information from a customer. In a preferred embodiment, the moving information is comprised of move specific details. In the preferred embodiment, the move specific details include, but are not limited to, an item inventory list, any special requests, a move-out date, a move-in date, a move-out location, a move-in location, loading conditions, unloading conditions, and a move type. In alternate embodiments, the move specific details may include additional or fewer inputs. One of ordinary skill in the art would appreciate that moving information could be comprised of a number of different move specific details, and embodiments of the present invention are contemplated to process any such move specific details.

According to an embodiment of the present invention, the move specific details include an item inventory list. In a preferred embodiment, the item inventory list is a list, inventory, or catalog of all of the items that a consumer or user of the moving service bid generator desires to have moved. When the customer information module requests the item inventory list, a consumer can list all of the items, such as furniture, boxes, and appliances, which they will need assistance with to move. The item inventory list is important for the later generation of a moving quote.

According to an embodiment of the present invention, the move specific details include any special requests. In a preferred embodiment, the special requests are particular tasks that a consumer may need assistance with as a part of their move. In the preferred embodiment, the special requests that a consumer might have include, but are not limited to, assistance with the assembly or disassembly of furniture or other items, assistance with packing (i.e. when the consumer wants assistance packing boxes, etc.), and special packing requests (i.e. special protection for sensitive items such as art or electronics). As is the case with all move specific details, the special requests are a factor in the generation of accurate moving quote.

According to an embodiment of the present invention, the move specific details include a move-out date. In a preferred embodiment, the move-out date is the date on which the consumer will need assistance in beginning their move. In the preferred embodiment, the move-out date may be a specific date. In an alternate preferred embodiment, the move-out date may be a range of dates.

According to an embodiment of the present invention, the move specific details include a move-in date. In a preferred embodiment, the move-in date is the date on which the consumer will need assistance to finish their move. In the preferred embodiment, the move-in date may be a specific date. In an alternate preferred embodiment, the move-in date may be a range of dates.

According to an embodiment of the present invention, the move specific details include a move-out location. In a preferred embodiment, the move-out location is the address or location that a consumer or user is leaving.

According to an embodiment of the present invention, the move specific details include a move-in location. In a preferred embodiment, the move-in location is the address or location that a consumer or user is moving to.

According to an embodiment of the present invention, the move specific details include loading conditions. In a preferred embodiment, the loading conditions are a variety of factors that may have an effect on the price of the moving quote. In the preferred embodiment, loading conditions will take into account a number of factors, including but not limited to the distance from the moving truck to the door of the move-out location, the number of stairs, whether the stairs are indoors or outdoors, the number of elevators (including whether the elevator can be reserved), and the size and other specifications of the elevators.

According to an embodiment of the present invention, the move specific details include unloading conditions. In a preferred embodiment, the unloading conditions are a variety of factors that may have an effect on the price of the moving quote. In the preferred embodiment, unloading conditions will take into account a number of factors, including but not limited to the distance from the moving truck to the door of the move-in location, the number of stairs, whether the stairs are indoors or outdoors, the number of elevators (including whether the elevator can be reserved), and the size and other specifications of the elevators.

According to an embodiment of the present invention, the move specific details include a move type. In a preferred embodiment, the move type is whether the move is a local move or a long distance move. In the preferred embodiment, the move type may determine how a mover determines the price. For example, the cost of a local move is typically determined on an hourly basis, whereas a long-distance move is determined on a combination of distance between move-out and move-in locations, as well as some measure of what items are being moved (i.e. weight and/or volume of the items being moved).

According to an embodiment of the present invention, the moving service bid generator includes a mover information module. In a preferred embodiment, the mover information module is configured to request, process and organize moving information from a mover or moving company. In the preferred embodiment, the mover information module may also coordinate with the customer information module in order to provide a moving quote to a consumer or similar user. One of ordinary skill in the art would appreciate that the mover information module could be configured to perform any number of tasks, and embodiments of the present invention are contemplated for performing any such task.

According to an embodiment of the present invention, the mover information module is configured to request, process and organize estimate information from a mover or moving company. In a preferred embodiment, the estimate information is comprised of estimate factors. In the preferred embodiment, the estimate factors include, but are not limited to, availability information, pricing unit, price per unit, loading cost adjustments, unloading cost adjustments, and special request cost adjustments. In alternate embodiments, the estimate information may include additional or fewer inputs. One of ordinary skill in the art would appreciate that estimate information could be comprised of a number of different estimate factors, and embodiments of the present invention are contemplated to process any such estimate factors.

According to an embodiment of the present invention, the estimate factors include availability information. In a preferred embodiment, the availability information is the availability schedule of the mover or moving company. In the preferred embodiment, the availability information is an important aspect in the determination of a moving quote. For example, the mover or moving company may adjust their prices according to availability. A primary illustration of this example is that a mover might charge higher rates near the beginning and ends of each month when consumers are more likely to be moving and the demand for services is higher. Conversely, a mover or moving company may charge lower rates during periods when demand is low, so that the mover or moving company can ensure that there is a constant demand for their services.

According to an embodiment of the present invention, the estimate factors include pricing unit. In a preferred embodiment, the pricing unit is a unit of measurement that is the primary basis for a mover's or moving company's moving quote. In a preferred embodiment, there may be three primary pricing units: 1) time, 2) weight, and 3) volume. The time measurement unit is when a moving quote is based upon the total time that a move is anticipated to take. In a preferred embodiment, the time measurement is measured in hours or fractions of an hour. For example if a move is estimated to take six hours then the consumer is charged at some determined rated multiplied by six hours. The time measurement unit is primarily utilized for local moves. On the other hand, the weight and volume measurement units are utilized for long distance moves. In a preferred embodiment, the weight and/or volume of the items to moved (as established by the item inventory list from the consumer) are determined and the moving quote is based primarily on the weight and/or volume of the items to be moved.

According to an embodiment of the present invention, the estimate factors include price per unit. In a preferred embodiment, the price per unit is the amount the mover or moving company charges per each pricing unit. In the preferred embodiment, the price per unit may be a number of dollars per hour, dollars per unit of weight, or dollars per unit of volume. The price per unit may include a variety of price points. For example, a mover or moving company may charge a higher rate per hour once a certain number of hours are reached or a higher rate based on the distance of the move (i.e. moves of 1-50 miles are charged $1 per cubic foot, or 50 cents per pound and moves of 50-100 miles are to $2 per cubic foot, or 0.75 cents). Alternatively, for moving quotes based on cost per unit of weight or cost per unit of volume, the mover of moving company may also factor in a mileage component (i.e. dollars per pound per miles (between move-out and move-in location)). One of ordinary skill in the art would appreciate there are a number of factors that could be considered/8 in the price per unit, and embodiments of the present invention are contemplated to take into account any such price per unit.

According to an embodiment of the present invention, the estimate factors include loading cost adjustments. In a preferred embodiment, the loading cost adjustments will take into account a number of factors, including but not limited to the distance from the moving truck to the door of the move-out location, the number of stairs, whether the stairs are indoors or outdoors, the number of elevators (including whether the elevator can be reserved), and the size and other specifications of the elevators. In the preferred embodiment, particularly for moves based on the weight or volume of the items being moved, the total weight or volume of items being moved can be multiplied by a number to account for such factors. For example each stair/step may be charged at a rate of 0.04 of the total weight of the items, each foot of distance from the truck to the door may be charged at a rate of 0.03 of the total weight of the items, and elevators may have varying rates depending on the elevator's size and whether or not it can be reserved (i.e. a rate of −0.01 for large, reserved elevator and 0.03 for a small, non-reserved elevator). These various loading cost adjustment factors help to take into account the amount of time it will take to move the items.

According to an embodiment of the present invention, the estimate factors include unloading cost adjustments. In a preferred embodiment, the unloading cost adjustments will take into account a number of factors, including but not limited to the distance from the moving truck to the door of the move-in location, the number of stairs, whether the stairs are indoors or outdoors, the number of elevators (including whether the elevator can be reserved), and the size and other specifications of the elevators. In the preferred embodiment, particularly for moves based on the weight or volume of the items being moved, the total weight or volume of items being moved can be multiplied by a number to account for such factors. For example each stair/step may be charged at a rate of 0.04 of the total weight of the items, each foot of distance from the truck to the door may be charged at a rate of 0.03 of the total weight of the items, and elevators may have varying rates depending on the elevator's size and whether or not it can be reserved (i.e. a rate of −0.01 for large, reserved elevator and 0.03 for a small, non-reserved elevator). These various unloading cost adjustment factors help to take into account the amount of time it will take to move the items.

According to an embodiment of the present invention, the estimate factors include special request cost adjustments. In a preferred embodiment, the special request cost adjustments are cost adjustments that a mover or moving company has for certain extra services. For example, the extra services might include assisting the consumer with the assembly or disassembly of furniture or other items, assistance with packing (i.e. when the consumer wants assistance packing boxes, etc.), and special packing requests (i.e. special protection for sensitive items such as art or electronics).

According to an embodiment of the present invention, the moving services bid generator will generate one or more moving quotes. In a preferred embodiment, the moving quotes are generated according to a price-it bid. In an alternate preferred embodiment, the moving quotes are generated according to a secret bid. In another preferred embodiment, the moving quotes are generated according to an open bid. One of ordinary skill in the art would appreciate that moving quotes could be generate and presented through a variety of methods, and embodiments of the present invention are contemplated for use with any such method.

According to an embodiment of the present invention, the moving quote is a price-it bid. In a preferred embodiment, a consumer may input all of the relevant customer information and further enter an amount or price they wish to pay for the move. This amount would then be compared to the price calculated by one or more movers. If the price that the consumer has entered meets, exceeds, or is within a certain range of what one of the movers calculated then a sale could take place.

According to an embodiment of the present invention, the moving quote is a secret bid. In a preferred embodiment, a consumer will enter all of the relevant customer information. Then one or more moving quotes will be calculated when the input of the customer information is compared to the mover information that has been entered by one or more companies. In the preferred embodiment, however, the identities of the mover or moving company will be kept secret, with only the moving quote and a select number of reviews for each company being presented to the consumer. The consumer can then make a choice based upon the price and/or reviews of the mystery moving companies.

According to an embodiment of the present invention, the moving quote is an open bid. In a preferred embodiment, a consumer will enter all of the relevant customer information. Then one or more moving quotes will be calculated when the input of the customer information is compared to the mover information that has been entered by one or more companies. Finally, a list of moving companies and each company's moving quote will be generated and displayed to the consumer.

According to a preferred embodiment of the present invention, a consumer will be able to book a mover or moving company directly through the system. In the preferred embodiment, a consumer would be required to directly book a mover through the system when utilizing price-it and secret bids. On the other hand, however, if the consumer was utilizing an open bid, the consumer would have the option of booking directly through the system, or alternatively booking by contacting the mover or moving company directly.

According to certain embodiments of the present invention, the system may be able to provide consumers with quotes on international moves or moves that cannot be completed via a land only route. In these embodiments, movers may be allowed to provide information related to such moves, such as cost per nautical mile, cost per miles travel via air or air freight. Information may be based on and quotes provided based on delivery schedule (e.g., lower rates for non-air moves). In certain embodiments of the present invention, movers may also be allowed to provide international connectivity, allowing the mover to note which international countries or areas (e.g., the European Union) they can provide moving services in and between. The system may also be configured to allow movers to provide quotes based on fees related to international moves (e.g., import/export taxes and duties).

### Exemplary Embodiment

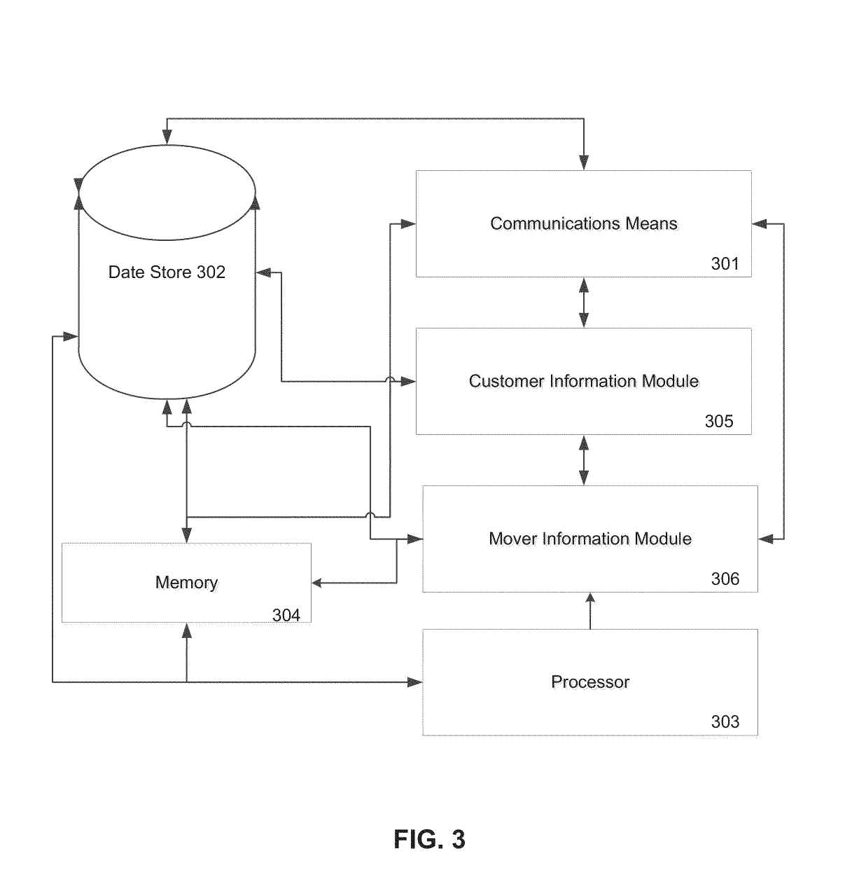

Turning now to FIG. 3, according to an embodiment of the present invention, the moving services bid generator and related methods herein described may be implemented through the use of one or more computing devices comprising a communications means 301, one or more data stores 302, a processor 303, a memory 304, a customer information module 305 and a mover information module 306 all communicatively connected. One or ordinary skill in the art would appreciate that there are numerous types of processors that could be utilized with embodiments of the present invention as well as numerous types of memory (e.g., Flash, RAM, ROM, cache, storage), and embodiments of the present invention are contemplated for use with any type of processor and memory.

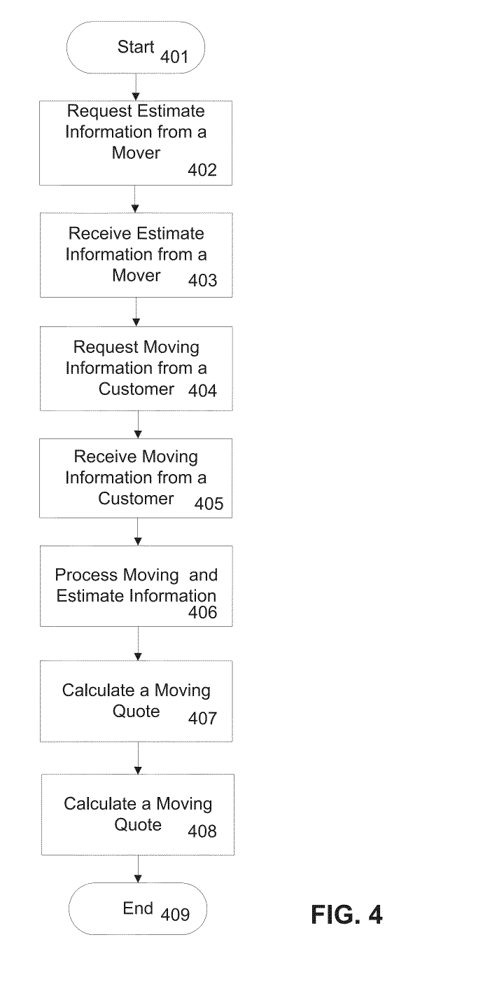

Turning now to FIG. 4, an exemplary process flow for a method of providing a marketplace for moving services is shown. The process starts at step 401, with a customer engaging the system.

At step 402, the mover information module requests estimate information from the mover or moving company. In a preferred embodiment, the requested moving information includes, but is not limited to, information about the availability of the mover and the mover's rates. In certain embodiments, the system may not need to request estimate information from a mover or moving company if the mover or moving company has previously entered a standard set of estimate information. Further, step 402 may be performed several times in conjunction with the proceeding step in order to keep information current (e.g., synchronization of availability/calendar).

At step 403, the mover or moving company inputs the estimate information into the mover information module. In a preferred embodiment, the mover or moving company may enter the estimate information regarding various move types, distance, and based on any other variable. This allows the mover or moving company to register a range of estimate information that can take into account the unique inputs that are provided by the customer information and automatically provide a moving quote without the mover or moving company responding to each individual quote request. In an alternate preferred embodiment, the mover or moving company inputs the estimate information when they are promoted to do so by the system (e.g., generally after receipt of a request from a person requesting moving service). This allows the mover or moving company to provide very precise information for each customer and moving quote based on the actual move to be performed.

At step 404, the customer information module requests moving information from the customer. In a preferred embodiment, the requested moving information includes, but is not limited to, information about what items are being moved, move-out/move-in date, move-out/move-in location, and special requests.

At step 405, the customer inputs the moving information into the customer information module.

At step 406, the customer information module, the mover information module, and the processor collaborate to process the moving information and the estimate information. In a preferred embodiment, the moving information is compared to the estimate information in order to generate a moving quote.

At step 407, the moving quote is calculated based upon the comparison of the moving information and the estimate information.

At step 408, the moving quote is provided to the customer.

At step 409, the process terminates with the customer selecting a moving quote. In a preferred embodiment the customer selects a moving quote and books their preferred mover through the system. In an alternate embodiment, the customer determines their preferred mover and moving quote and contacts that mover independent of the system.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing a marketplace for moving services, the system comprising:
a moving services bid generator, comprising a
a customer information module comprising computer-executable code stored in non-volatile memory,
a mover information module comprising computer-executable code stored in non-volatile memory,
a processor, and
a communications means,
wherein said customer information module, said mover information module, said processor, and said communications means are operably connected and are configured to:
request estimate information from one or more movers, via said mover information module, wherein said estimate information is comprised of one or more estimate factors selected from a group of estimate factors comprising availability information, pricing unit, price per unit, loading cost adjustments, unloading cost adjustments, and special request cost adjustments;
receive said estimate information from said one or more movers, wherein said one or more movers input said one or more estimate factors;
request moving information from a customer, via said customer information module, wherein said moving information is comprised of one or more move specific details selected from a group of move specific details comprising an item inventory list, special requests, a move-out date, a move-in date, a move-out location, a move-in location, loading conditions, unloading conditions, and move type;
receive said moving information from said customer, wherein said customer inputs said one or more move specific details;
process said moving information and said estimate information; wherein said customer information module and said mover information module cooperate to compare said moving information to said estimate information;
calculate one or more moving quotes, wherein said one or more moving quotes is based on a comparison of said moving information and said estimate information,
wherein said one or more moving quotes are calculated according to a bid method selected from a group of bid methods comprising price-it bid method, secret bid method, and open bid method; and
provide said one or more moving quotes to said customer, wherein each of said one or more moving quotes is associated with at least one of said one or more movers that provided said estimate information.

2. The system of claim 1, wherein said moving services bid generator, is further configured to receive a mover selection from said customer based on said customer selecting a preferred moving quote from said one or more moving quotes.

3. The system of claim 1, wherein said move type is selected from a group of move types comprising local moves and long distance moves.

4. The system of claim 1, wherein said pricing unit is selected from a group of pricing units comprising, price per unit of time, price per unit of volume, and price per unit of weight.

5. The system of claim 1, wherein said price-it bid method comprises receiving a favored price from said customer, comparing said favored price to said estimate information that is associated with at least one of said one or more movers, and approving said favored price if said favored price is within a designated range of said estimate information associated with at least one of said one or more movers.

6. The system of claim 1, wherein said secret bid method hides each of said one or more movers specific identities from said customer and instead provides one or more customer reviews and a mover rating for each of said one or more movers so that said customer can make said mover selection.

7. The system of claim 1, wherein said open bid method shows each of said one or more movers specific identities to said customer so that said customer can make said mover selection.

8. A method for providing a marketplace for moving services, the method comprising the steps of:
requesting estimate information from one or more movers, via said mover information module, wherein said estimate information is comprised of one or more estimate factors selected from a group of estimate factors comprising availability information, pricing unit, price per unit, loading cost adjustments, unloading cost adjustments, and special request cost adjustments;
receiving said estimate information from said one or more movers, wherein said one or more movers input said one or more estimate factors;
requesting moving information from a customer, via said customer information module, wherein said moving information is comprised of one or more move specific details selected from a group of move specific details comprising an item inventory list, special requests, a move-out date, a move-in date, a move-out location, a move-in location, loading conditions, unloading conditions, and move type;
receiving said moving information from said customer, wherein said customer inputs said one or more move specific details;
processing said moving information and said estimate information; wherein said customer information module and said mover information module cooperate to compare said moving information to said estimate information;
calculating one or more moving quotes, wherein said one or more moving quotes is based on a comparison of said moving information and said estimate information; and
providing said one or more moving quotes to said customer, wherein each of said one or more moving quotes is associated with at least one of said one or more movers that provided said estimate information.

9. The method of claim 8, further comprising the step of receiving a mover selection from said customer based on said customer selecting a preferred moving quote from said one or more moving quotes.

10. The method of claim 8, wherein said move type is selected from a group of move types comprising local moves and long distance moves.

11. The method of claim 8, wherein said pricing unit is selected from a group of pricing units comprising, price per unit of time, price per unit of volume, and price per unit of weight.

12. The method of claim 8, wherein said price-it bid method comprises receiving a favored price from said customer, comparing said favored price to said estimate information that is associated with at least one of said one or more movers, and approving said favored price if said favored price is within a designated range of said estimate information associated with at least one of said one or more movers.

13. The method of claim 8, wherein said secret bid method hides each of said one or more movers specific identities from said customer and instead provides one or more customer reviews and a mover rating for each of said one or more movers so that said customer can make said mover selection.

14. The method of claim 8, wherein said open bid method shows each of said one or more movers specific identities to said customer so that said customer can make said mover selection.
